(19) United States
(12) Patent Application Publication
(10) Pub. No.: US 2026/0162330 A1
(43) Pub. Date: Jun. 11, 2026

(54) APPARATUS AND METHOD FOR GENERATING PANORAMIC IMAGE USING CONTENT INFORMATION

(71) Applicant: VISIT INC., Wonju-si Gangwon-do (KR)

(72) Inventors: Geun Woong RYU, Seoul (KR); Geon Hui LEE, Seoul (KR); Yong Won CHO, Seoul (KR)

(73) Assignee: VISIT INC., Wonju-si Gangwon-do (KR)

(21) Appl. No.: 19/179,179

(22) Filed: Apr. 15, 2025

Related U.S. Application Data
(63) Continuation of application No. PCT/KR2023/019877, filed on Dec. 5, 2023.

(30) Foreign Application Priority Data
Jul. 21, 2023 (KR) 10-2023-0095565

(51) Int. Cl. G06T 11/60; G06V 10/22

(52) U.S. Cl. CPC G06T 11/60; G06V 10/22

(57) ABSTRACT

The present disclosure relates to a panoramic image generation apparatus and method. The panoramic image generation apparatus according to an embodiment of the present disclosure may include a reception unit configured to receive input information required to provide a panoramic image; an image provision unit configured to provide the panoramic image to a user based on the input information; and a data selection unit configured to select hotspot content having higher relevance to the panoramic image from among pieces of content information located within a preset range based on location information of the panoramic image, wherein the image provision unit provides the panoramic image together with the hotspot content.

### CROSS-REFERENCE TO RELATED APPLICATIONS

This application is a continuation of International Application No. PCT/KR2023/019877 filed on Dec. 5, 2023, which claims priority to Korean Patent Application No. 10-2023-0095565 filed on Jul. 21, 2023, the entire contents of which are herein incorporated by reference.

### TECHNICAL FIELD

The present disclosure relates to an apparatus and method for generating a panoramic image using content information, and more particularly, to an apparatus and method for generating a panoramic image required to provide hotspot content onto a panoramic image based on content information uploaded by users.

### BACKGROUND ART

A conventional panoramic image generation apparatus provides a panoramic image to a user while a capturing operator is moving a certain distance.

The panoramic image generation apparatus provides a road view service that enables a virtual tour to a user in such a way as to display an arrow, indicating a location at which an image is present within a certain distance, on a panoramic image, display a panoramic image corresponding to a clicked location when the user clicks the arrow, and indicate a panoramic image, on which a panoramic image present within a certain distance is displayed based on the displayed panoramic image, by an arrow.

However, although the road view service is provided by allowing a map provider to personally connect a certain number of panoramic images moved a certain distance to a linked arrow, the locations of a plurality of pieces of content are not standardized in a user-participatory map platform service, thus making it difficult to provide content within a certain distance based on a panoramic image in the form of a road view.

### SUMMARY

### Technical Problem

It is intended to provide an apparatus and method for generating a panoramic image, in which content having high importance based on a capturing location is displayed on a panoramic image according to an embodiment of the present disclosure.

### Technical Solution

A panoramic image generation apparatus according to an aspect of an embodiment of the present disclosure includes a reception unit configured to receive input information required to provide a panoramic image; an image provision unit configured to provide the panoramic image to a user based on the input information; and a data selection unit configured to select hotspot content having higher relevance to the panoramic image from among pieces of content information located within a preset range based on location information of the panoramic image, wherein the image provision unit provides the panoramic image together with the hotspot content.

In addition, the data selection unit may include a data preprocessing unit configured to calculate a mean distance to the content information based on the location information, and determine, based on the calculated mean distance, whether the content information is included in a dataset that is a target of selection of the hotspot content.

In addition, the data preprocessing unit may be configured to calculate a mean standard deviation with the content information based on the mean distance, sequentially calculate, based on the mean distance, distance intervals between pieces of adjacent content information in an order from closest content information before the mean distance to farthest content information after the mean distance, and when a corresponding distance interval is greater than the mean standard deviation, exclude content information that is a target of calculation of subsequent distance intervals from the dataset.

In addition, the data selection unit may include a clustering unit configured to generate at least one cluster corresponding to a viewing angle direction by performing density-based clustering on the dataset based on an Euler angle.

In addition, the clustering unit may determine a number of pieces of hotspot content for each cluster based on a number of pieces of content information included in a corresponding cluster.

In addition, the clustering unit may determine the number of pieces of hotspot content for each cluster using the following equation:

$$N \leq a + ( b \times k ) ( where N is an integer ) \qquad equation$$

(where N denotes the number of pieces of hotspot content for each cluster, a denotes a minimum number of pieces of hotspot content for each cluster, b denotes a ratio of additionally selected content information to a total number of pieces of content information for each cluster, and k denotes the total number of pieces of content information for each cluster).

In addition, the minimum number of pieces of hotspot content for each cluster may be at least one.

In addition, the data selection unit may include a data post-processing unit configured to calculate content importance based on popularity of the content information, an address similarity between the location information and the content information, and a distance between the location information and the content information, and select the hotspot content in descending order of content importance.

In addition, the data post-processing unit may be configured to calculate the content importance differently depending on a category in which the panoramic image is displayed, when the category is a Social Network Service (SNS), calculate the content importance by setting a weight applied to the popularity to a value greater than a weight applied to the distance between the location information and the content information, and when the category is a road view, calculate the content importance by setting the weight applied to the distance between the location information and the content information to a value greater than the weight applied to the popularity.

A panoramic image generation method according to an aspect of an embodiment of the present disclosure includes, in a panoramic image generation method using a panoramic image generation apparatus, an input information reception step of receiving input information required to provide a panoramic image; a data selection step of selecting hotspot content having high relevance to the panoramic image from among pieces of content information located within a preset range based on location information of the panoramic image; and an image provision step of providing the panoramic image to a user based on the input information, wherein the image provision step includes providing the panoramic image together with the hotspot content.

In addition, the data selection step may include a data preprocessing step of calculating a mean distance to the content information based on the location information and determining, based on the calculated mean distance, whether the content information is included in a dataset that is a target of selection of the hotspot content.

In addition, the data preprocessing step may include calculating a mean standard deviation with the content information based on the mean distance, sequentially calculating, based on the mean distance, distance intervals between pieces of adjacent content information in an order from closest content information before the mean distance to farthest content information after the mean distance, and when a corresponding distance interval is greater than the mean standard deviation, excluding content information that is a target of calculation of subsequent distance intervals from the dataset.

In addition, the data selection step may include a clustering step of generating at least one cluster corresponding to a viewing angle direction by performing density-based clustering on the dataset based on an Euler angle.

In addition, the clustering step may include determining a number of pieces of hotspot content for each cluster based on a number of pieces of content information included in a corresponding cluster.

In addition, in the clustering step, the number of pieces of hotspot content for each cluster may be determined using the following equation:

$$N \leq a + ( b \times k ) ( where N is an integer ) \qquad equation$$

(where N denotes the number of pieces of hotspot content for each cluster, a denotes a minimum number of pieces of hotspot content for each cluster, b denotes a ratio of additionally selected content information to a total number of pieces of content information for each cluster, and k denotes the total number of pieces of content information for each cluster).

In addition, the minimum number of pieces of hotspot content for each cluster may be at least one.

In addition, the data selection step may include a data post-processing step of calculating content importance based on popularity of the content information, an address similarity between the location information and the content information, and a distance between the location information and the content information, and selecting the hotspot content in descending order of content importance.

In addition, the data post-processing step may include calculating the content importance differently depending on a category in which the panoramic image is displayed, when the category is a Social Network Service (SNS), calculating the content importance by setting a weight applied to the popularity to a value greater than a weight applied to the distance between the location information and the content information, and when the category is a road view, calculating the content importance by setting the weight applied to the distance between the location information and the content information to a value greater than the weight applied to the popularity.

### Advantageous Effects

According to proposed embodiments, there is an advantage in that several techniques may be combined with each other to select hotspot content having high importance from unnormalized content information, and thus the hotspot content may be displayed on a panoramic image.

### DESCRIPTION OF DRAWINGS

FIG. 1 is an exemplary diagram illustrating a conventional panoramic image generated using content information.

FIG. 2 is a diagram illustrating a panoramic image generation system including a panoramic image generation apparatus according to an embodiment of the present disclosure.

FIG. 3 is a block diagram schematically illustrating the configuration of the panoramic image generation apparatus in the panoramic image generation system of FIG. 2.

FIG. 4 is a flowchart illustrating a panoramic image generation method performed by the panoramic image generation apparatus of FIG. 3.

FIG. 5 is an exemplary diagram illustrating a process in which the panoramic image generation apparatus of FIG. 3 selects content information located within a preset range based on location information.

FIG. 6 is an exemplary diagram illustrating a process in which the panoramic image generation apparatus of FIG. 3 determines whether content: information is included in a dataset based on a mean distance.

FIG. 7 is an exemplary diagram illustrating a plurality of clusters generated by the panoramic image generation apparatus of FIG. 3.

FIG. 8 is an exemplary diagram illustrating a process in which the panoramic image generation apparatus of FIG. 3 determines the number of pieces of hotspot content for each cluster.

### BEST MODE

Advantages and features of the present disclosure, and methods for achieving the same will be cleared with reference to embodiments described later in detail together with the accompanying drawings. However, the present disclosure is not limited to embodiments disclosed below, but may be implemented in various different forms, the present embodiments are provided to fully describe the present disclosure and to fully convey the scope of the disclosure to those skilled in the art to which the present disclosure pertains, and the present disclosure is defined only by the scope of the accompanying claims.

Although terms such as first or second are used to describe various components, it is apparent that those components are not limited by these terms. These terms are merely used to distinguish one component from other components. Therefore, it is apparent that a first component described below may be a second component without departing from the technical spirit of the present disclosure.

The same reference numerals refer to the same components throughout the specification.

The features of various embodiments of the present disclosure may be partially or entirely combined or integrated with each other, various technical interconnections and operations are possible, as will be sufficiently understood by those skilled in the art, and individual embodiments may be implemented either independently or in conjunction with others in an interrelated manner.

Meanwhile, potential effects that can be expected from the technical features of the present disclosure and that are not explicitly mentioned in the specification of the present disclosure may be treated as described herein, and the present embodiments are provided to more completely explain the present disclosure to those skilled in the art, and thus the contents illustrated in the drawings may be exaggerated compared to the actual implementation of the disclosure, and detailed descriptions of configurations deemed to unnecessarily obscure the gist of the present disclosure are omitted or made in brief.

Hereinafter, embodiments of the present disclosure will be described in detail with reference to the attached drawings.

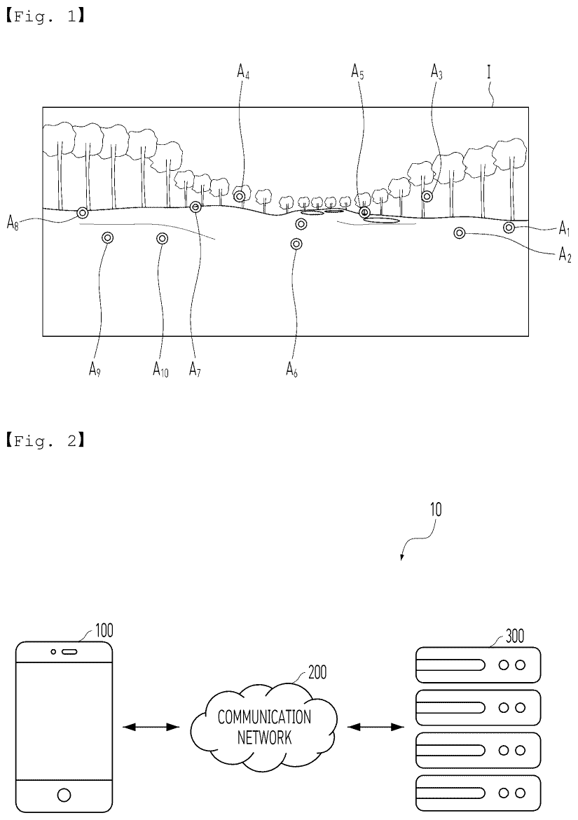

FIG. 1 is an exemplary diagram illustrating a conventional panoramic image generated using content information C.

Referring to FIG. 1, a user may capture content information C, which is a panoramic image including location information O, which is captured by the user using a user device 100.

A panoramic image generation apparatus 300 may receive the content information C from the user device 100, generate a panoramic image I based on geographical information, and display the content information C, as hotspot content A, on the panoramic image I.

Here, the panoramic image generation apparatus 300 may allow the user to select hotspot content A corresponding to a viewing angle direction of the panoramic image desired to be viewed by the user using the user device 100 by displaying hotspot content on the panoramic image I captured at any one location based on the location information O, thus allowing the user to view the content information C connected to the hotspot content A.

However, the conventional user-participatory content-based panoramic image generation apparatus 300, which allows the user to personally capture an image and post the corresponding content, is problematic in that, when an unspecified large number of people upload content information C in the same space, multiple pieces of hotspot content A₁, A₂, A₃, A₄, A₅, A₆, A₇, A₈, A₉, and A₁₀ are displayed in all directions of the panoramic image I.

Also, since pieces of received content information C on the panoramic image are not normalized, a problem arises in that all of the pieces of content information are displayed as pieces of hotspot content A₁, A₂, A₃, A₄, A₅, A₆, A₇, A₈, A₉, and A₁₀ on the panoramic image, or in that only pieces of content information C within a certain distance range based on the location information O are displayed as pieces of hotspot content A, thus causing pieces of unrefined content information C to be jumbled up on the panoramic image.

Therefore, the panoramic image generation apparatus 300 according to the present disclosure may select content information C having high importance from among pieces of unnormalized content information C using multiple processing methods, and may provide hotspot content A corresponding to the selected content information C, together with the panoramic image.

Further, according to the proposed embodiment, content information C fitted to various platforms that utilize the panoramic image I may be provided by selecting pieces of hotspot content A using various types of information separately from the location information O of the content information C.

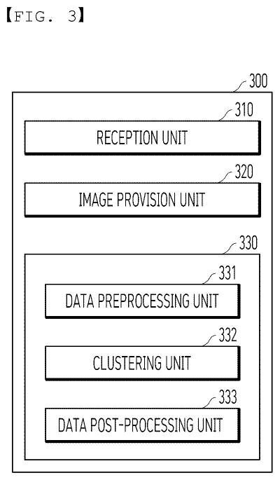

FIG. 2 is a diagram illustrating a panoramic image generation system including a panoramic image generation apparatus according to an embodiment of the present disclosure.

Referring to FIG. 2, a panoramic image generation system 10 may include a user device 100 and panoramic image generation apparatuses 300.

The user device 100 may transmit content information C captured by the user and location information O of the content information C to the panoramic image generation apparatuses 300 over a communication network 200.

Here, the content information C may be information about content such as video or audio, created based on the location information O, but the content information C may desirably be a panoramic image in which a plurality of images are aligned.

The user device 100 may transmit the content information C to the panoramic image generation apparatuses 300, and each of the panoramic image generation apparatuses 300 may provide the content information C to the user device 100 so that the content information C is displayed on the panoramic image in the form of pieces of hotspot content A.

The user device 100 may receive the pieces of hotspot content A and the panoramic image from the panoramic image generation apparatus 300 and display the pieces of hotspot content A on the panoramic image to allow the user to select at least one piece of hotspot content A displayed on the panoramic image.

When the user selects the hotspot content A displayed on the panoramic image through the user device 100, the user device 100 may request content information C corresponding to the selected hotspot content A from the panoramic image generation apparatus 300, and the panoramic image generation apparatus 300 may transmit the content information C, which is a panoramic image, to the user device 100, thus allowing the user to view a panoramic image that is content information located in any one direction of a previously viewed panoramic image.

Therefore, the user may check pieces of content information present in respective positional directions based on the panoramic image using the user device 100, thus utilizing a virtual tour or road view based on the panoramic image received from the panoramic image generation apparatus 300.

The user device 100 may be connected to the panoramic image generation apparatus 300 over the communication network 200.

The communication network 200 refers to a connection structure that enables information exchange to be performed between individual nodes such as a plurality of terminals and servers, and examples of such a network include a Local Area Network (LAN), a Wide Area Network (WAN), the Internet (World Wide Web: WWW), a wired/wireless data communication network, a telephone network, a wired/wireless television communication network, and the like. Examples of the wireless data communication network may include, but are not limited to, 3G, 4G, 5G, 3rd Generation Partnership Project (3GPP), 5th Generation Partnership Project (5GPP), Long Term Evolution (LTE), World Interoperability for Microwave Access (WIMAX), Wi-Fi, the Internet, a Local Area Network (LAN), a Wireless Local Area Network (Wireless LAN), a Wide Area Network (WAN), a Personal Area Network (PAN), Radio Frequency (RF), a Bluetooth network, a Near-Field Communication (NFC) network, a satellite broadcasting network, an analog broadcasting network, a Digital Multimedia Broadcasting (DMB) network, and the like.

The panoramic image generation apparatus 300 may provide a panoramic image to the user device 100 based on input information entered through the user device 100, thereby allowing the user to be provided with a panoramic image associated with geographical information.

Here, the panoramic image generation apparatus 300 may select content information based on the location information O of the panoramic image, and may then provide the panoramic image and hotspot content A, which is the selected content information.

In an example, the panoramic image generation apparatus 300 may be, but is not limited to, a server, and the panoramic image generation apparatus 300 may be a smart device and a device including a control unit that is capable of providing the panoramic image and the hotspot content A.

In the present embodiment, although a configuration in which the user device 100 requests a panoramic image from the panoramic image generation apparatus 300 using the communication network 200 and in which the panoramic image generation apparatus 300 provides the panoramic image to the user device 100 has been disclosed, the present embodiment is not limited thereto, and it is possible to implement a configuration in which, when a panoramic image is provided from a panoramic image database stored in the storage unit of the user device 100 and the user selects at least one piece of hotspot content A based on the panoramic image displayed via the user device 100, content information C corresponding to the hotspot content A may be provided to the user.

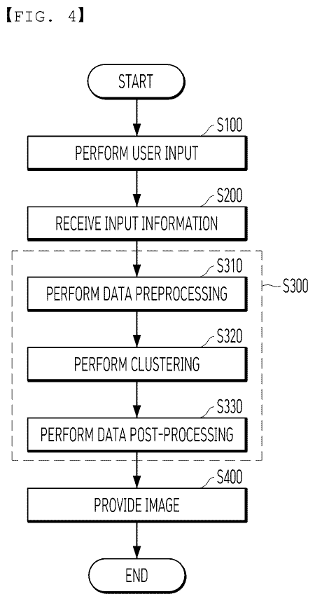

FIG. 3 is a block diagram schematically illustrating the configuration of the panoramic image generation apparatus in the panoramic image generation system of FIG. 2.

Referring to FIG. 3, the panoramic image generation apparatus 300 may include a reception unit 310, an image provision unit 320, and a data selection unit 330. The panoramic image generation apparatus 300 may include one or more processors and memory modules storing instructions. The reception unit 310, the image provision unit 320, and the data selection unit 330 may be processors or program modules stored in the memory modules.

First, the reception unit 310 may receive input information required to provide a panoramic image.

In detail, the reception unit 310 may receive input information about the panoramic image desired to be received by a user device 100 from the panoramic image generation apparatus 300.

In an example, although the reception unit 310 may be a communication module capable of receiving data using the communication network 200, it is not limited thereto, and may be one of input modules capable of receiving input information from the user.

Although the input information may be either geographical information or location information O displayed on the panoramic image, it is not limited thereto, and the input information may be separate coordinate information required to receive a specific panoramic image.

The image provision unit 320 may provide the panoramic image to the user based on the input information, and the image provision unit 320 may provide the panoramic image together with the hotspot content A.

In detail, the user may transmit the location information O at which the panoramic image is desired to be provided through the user device 100 to the panoramic image generation apparatus 300, the reception unit 310 may receive the input information including the location information O at which the panoramic image is desired to be provided, and the image provision unit 320 may provide the panoramic image corresponding to the location information O and the hotspot content A to be displayed on the panoramic image, which will be described later, to the user device 100 used by the user based on the received input information.

Here, when multiple pieces of hotspot content selected from the same cluster are provided, the image provision unit 320 may provide the multiple pieces of hotspot content to the user in the form of one hotspot, and may then provide multiple pieces of content information included in the same cluster to the user when the user selects pieces of hotspot content provided in the form of one hotspot.

The image provision unit 320 may further simplify multiple pieces of hotspot content located in a similar direction by providing pieces of hotspot content included in the same cluster in the form of one hotspot, thus decreasing the complexity of the hotspot content A displayed on the panoramic image.

The data selection unit 330 may select hotspot content A having higher relevance to the panoramic image from among pieces of content information C located within a preset range based on the location information O of the panoramic image.

Here, the data selection unit 330 may include a data preprocessing unit 331, a clustering unit 332, and a data post-processing unit 333. The data preprocessing unit 331, the clustering unit 332, and the data post-processing unit 333 may be processors or program modules stored in the memory modules.

First, the data selection unit 330 may include the data preprocessing unit 331 that calculates a mean distance M to the content information C based on the location information O of the panoramic image and determines whether the content information C is included in a dataset that is the target of selection of the hotspot content A based on the calculated mean distance M.

In detail, the data preprocessing unit 331 may calculate the mean standard deviation with respect to the content information C based on the mean distance M, and then sequentially calculate, based on the mean distance M, the distance intervals between pieces of adjacent content information in the order from the closest content information before the mean distance to the farthest content information after the mean distance, wherein, when the corresponding distance interval exceeds the mean standard deviation, content information that is the target of calculation of the subsequent distance intervals may be excluded from the dataset.

Here, the dataset may be a dataset of pieces of content information, which is the target of selection of hotspot content, or a set of pieces of content information present within a range from the location information of the panoramic image to the farthest content information that is the target of selection of hotspot content.

Here, the mean distance M may be calculated by the following Equation 1.

$$M = \frac{( {r}_{1} + … + {r}_{n} )}{n} \qquad [ Equation 1 ]$$

That is, the mean distance M may be a value obtained by dividing the total sum of distances r from the location information of the panoramic image to pieces of content information C falling within a preset range by the number of pieces of content information n.

Further, the mean standard deviation may be calculated by the following Equation 2.

$$σ = c \sqrt{\frac{{( {r}_{1} - M )}^{2 +} … + {( {r}_{n} - M )}^{2}}{n}} \qquad [ Equation 2 ]$$

(where σ denotes the mean standard deviation, c denotes a mean standard deviation coefficient, r denotes the distance of content information, M denotes the mean distance, and n denotes the number of pieces of content information)

Also, the data selection unit 330 may include the clustering unit 332 that generates at least one cluster corresponding to a viewing angle direction by performing density-based clustering on the dataset based on Euler angles.

Here, an Euler angle may be the value of at least one of yaw, pitch or roll angles of each piece of content information C based on the location information O of the panoramic image.

Here, the clustering unit 332 may group pieces of concentrated content information by performing density-based clustering that is a data clustering algorithm.

In an example, the density-based clustering may be, but is not limited to, one of MeanShift, DBSCAN, HDBSCAN, or K-Means algorithms, and the density-based clustering may be an algorithm of performing clustering based on the density of data.

In the present embodiment, a configuration in which the clustering unit 332 groups pieces of content information by performing density-based clustering has been disclosed, but the present disclosure is not limited thereto, and may perform clustering on content information concentrated in any one area.

The clustering unit 332 may determine the number of pieces of hotspot content for each cluster based on the number of pieces of content information included in each cluster.

Here, the clustering unit 332 may determine the number of pieces of hotspot content for each cluster using the following Equation 3.

$$N \leq a + ( b \times k ) \qquad [ Equation 3 ]$$

(where N denotes the number of pieces of hotspot content for each cluster, a denotes the minimum number of pieces of hotspot content for each cluster, b denotes the ratio of additionally selected content information to the total number of pieces of content information for each cluster, and k denotes the total number of pieces of content information for each cluster)

In an example, in the case where the minimum number of pieces of hotspot content for each cluster is 1 and the ratio of additionally selected content information to the total number of pieces of content information for each cluster is set to 0.1, when the number of pieces of content information for each cluster is 10, the clustering unit 332 may select the number of pieces of hotspot content for each cluster as 2, whereas when the number of pieces of content information for each cluster is 15, the clustering unit 332 may select the number of pieces of hotspot content for each cluster as 2 equal to that when the number of pieces of content information for each cluster is 10.

Here, although the minimum number of pieces of hotspot content for each cluster may be 0, it may be set to at least one, and thus the clustering unit 332 may select at least one piece of hotspot content for each cluster, and the panoramic image generation apparatus 300 may provide at least one piece of hotspot content corresponding to a viewing angle direction onto the panoramic image.

Furthermore, the data selection unit 330 may include the data post-processing unit 333 that calculates content importance based on the popularity of the content information C, address similarity between the location information O and the content information C, and the distance between the location information O and the content information C, and selects the hotspot content in descending order of content importance.

Here, the popularity of content information may be, but is not limited to, at least one of the number of views indicating the number of views of the content information by users, bookmarks, or the citation rate of the content information, and may be a parameter that indicates the measure of user interest.

Further, the data post-processing unit 333 may calculate an address similarity value by determining the address similarity between the location information O and the content information C.

The data post-processing unit 333 may calculate the address similarity value using a known string similarity determination technique, such as a string similarity algorithm or an artificial intelligence algorithm between an address corresponding to the location information O of the panoramic image and an address corresponding to the location of the content information C.

In this case, the data post-processing unit 333 calculates content importance based on the address similarity value, thus providing hotspot content A, which is selected to enable movement to a building sharing the same address or a periphery having a similar address, to the user.

The data post-processing unit 333 may differently calculate the content importance depending on the category in which the panoramic image is displayed in such a way that, when the category is a Social Network Service (SNS), the content importance is calculated by setting a weight applied to the popularity to a value greater than a weight applied to the distance between the location information O and the content information C, and when the category is a road view, the content importance is calculated by setting a weight applied to the distance between the location information O and the content information C to a value greater than the weight applied to the popularity.

Here, the category may be a platform or a service that exploits a panoramic image used by the user through the user device 100, and may be, for example, SNS, road view, a restaurant recommendation application service, or the like.

When the category in which the panoramic image is displayed is SNS, mentions, view counts, and the like, among users who use the SNS, may serve as important parameters, and thus the data post-processing unit 333 may set a popularity weight corresponding thereto to a value greater than weights corresponding to other parameters.

Further, when the category in which the panoramic image is displayed is a road view, the data post-processing unit 333 needs to provide content information C closest to the location information O at which the panoramic image is captured, and thus the weight to be applied to the distance between the location information O of the panoramic image and the content information may be set to a greater value.

Since the data post-processing unit 333 calculates the content importance differently depending on the category to provide the hotpot content of the panoramic image in different forms, there is an advantage in that hotspot content fitted to the platform and service that are used by the user can be provided.

FIG. 4 is a flowchart illustrating a panoramic image generation method performed by the panoramic image generation apparatus of FIG. 3.

Referring to FIG. 4, the panoramic image generation method using the panoramic image generation apparatus may include user input step S100, input information reception step S200, data selection step S300, and image provision step S400.

First, in user input step S100, a user device 100 may transmit input information required to receive a panoramic image to the panoramic image generation apparatus 300.

Here, in user input step S100, the user device 100 may receive the input information from a user, and transmit the same to the panoramic image generation apparatus 300, but the user input step is not limited thereto, and the user may personally enter the input information into the panoramic image generation apparatus 300, after which, in image provision step S400, which will be described later, the user may be provided with a panoramic image through the user device 100 or the panoramic image generation apparatus 300.

In input information reception step S200, the panoramic image generation apparatus 300 may receive the input information required to provide the panoramic image.

In data selection step S300, the panoramic image generation apparatus 300 may select hotspot content that has higher relevance to the panoramic image from among pieces of content information located within a preset range based on location information O of the panoramic image.

In detail, data selection step S300 may include data preprocessing step S310, clustering step S320, and data post-processing step S330.

First, data selection step S300 may include data preprocessing step S310 where the panoramic image generation apparatus 300 calculates a mean distance M to the content information C based on the location information O and determines whether the content information C is included in a dataset that is the target of selection of hotspot content A based on the calculated mean distance M.

In data preprocessing step S310, the panoramic image generation apparatus 300 may calculate mean standard deviation with the content information C based on the mean distance M, and then sequentially calculate, based on the mean distance M, the distance intervals between pieces of adjacent content information in the order from the closest content information before the mean distance M to the farthest content information after the mean distance M, wherein, when the corresponding distance interval exceeds the mean standard deviation, content information that is the target of calculation of the subsequent distance intervals may be excluded from the dataset.

Next, data selection step S300 may include clustering step S320 where the panoramic image generation apparatus 300 generates at least one cluster corresponding to a viewing angle direction by performing density-based clustering on the dataset based on Euler angles.

In clustering step S320, the panoramic image generation apparatus 300 may determine the number of pieces of hotspot content for each cluster based on the number of pieces of content information included in each cluster.

In clustering step S320, the panoramic image generation apparatus 300 may determine the number of pieces of hotspot content for each cluster using the following Equation 3.

$$N \leq a + ( b \times k ) ( where N is an integer )$$

(where N denotes the number of pieces of hotspot content for each cluster, a denotes the minimum number of pieces of hotspot content for each cluster, b denotes the ratio of additionally selected content information to the total number of pieces of content information for each cluster, and k denotes the total number of pieces of content information for each cluster)

Here, the minimum number of pieces of hotspot content for each cluster may be 0, but it may be at least one.

Subsequently, data selection step S300 may include data post-processing step S330 where the panoramic image generation apparatus 300 calculates content importance based on the popularity of the content information, the address similarity between the location information O and the content information, and the distance between the location information and the content information, and selects hotspot content A in descending order of the content importance.

In data post-processing step S330, the panoramic image generation apparatus 300 may differently calculate the content importance depending on the category in which the panoramic image is displayed in such a way that, when the category is a Social Network Service (SNS), the content importance is calculated by setting a weight applied to the popularity to a value greater than a weight applied to the distance between the location information O and the content information C, and when the category is a road view, the content importance is calculated by setting a weight applied to the distance between the location information O and the content information C to a value greater than the weight applied to the popularity.

In image provision step S400, the panoramic image generation apparatus 300 may provide the panoramic image to the user based on the input information.

Here, in image provision step S400, the panoramic image generation apparatus 300 may provide the panoramic image together with the hotspot content A.

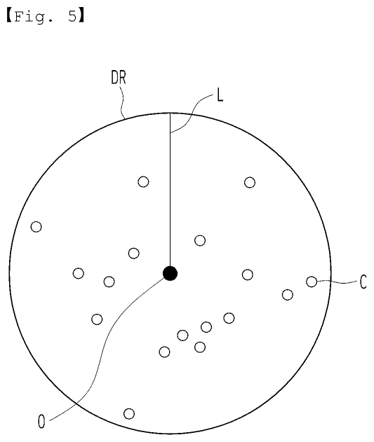

FIG. 5 is an exemplary diagram illustrating a process in which the panoramic image generation apparatus of FIG. 3 selects content information C located within a preset range based on location information O.

Referring to FIG. 5, the reception unit 310 of the panoramic image generation apparatus 300 may receive input information required to provide a panoramic image.

Here, the image provision unit 320 of the panoramic image generation apparatus 300 may provide the panoramic image based on the input information, and, in this case, the data selection unit 330 may select hotspot content that has higher relevance to the panoramic image from among pieces of content information C located within a preset range DR based on the location information O of the panoramic image, which is included in the input information.

Here, the preset range DR may be a range generated based on a preset distance L for selecting the hotspot content A that has higher relevance to the panoramic image.

The image provision unit 320 of the panoramic image generation apparatus 300 first selects the content information C located within the preset range DR based on the location information O, thus selecting hotspot content from among pieces of content information C around the location at which the panoramic image is captured, and excluding pieces of content information that are captured at locations farther away from the location information O at which the panoramic image is captured and that have lower relevance to the panoramic image.

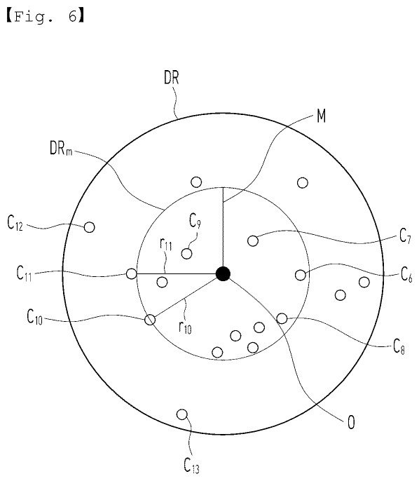

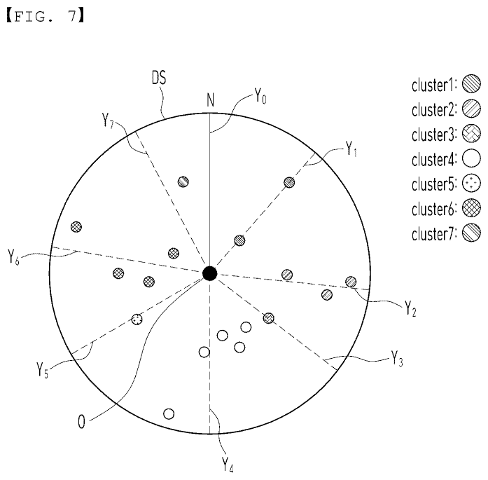

FIG. 6 is an exemplary diagram illustrating a process in which the panoramic image generation apparatus of FIG. 3 determines whether content information is included in a dataset based on the mean distance M.

Referring to FIG. 6, the data preprocessing unit 331 of the panoramic image generation apparatus 300 may calculate the mean distance M to content information C based on location information O of a panoramic image and determine whether the content information is included in a dataset that is the target of selection of the hotspot content A based on the calculated mean distance M.

Here, the data preprocessing unit 331 may include pieces of content information C₆, C₇, C₈, and C₉ located within the mean distance M based on the location information O of the panoramic image in the dataset that is the target of selection of hotspot content, may additionally determine whether content data, located out of the mean distance M, is to be included in the dataset that is the target of selection of the hotspot content A, and may then exclude pieces of data, relatively far away from the location information O of the provided panoramic image, from the hotspot content A.

In detail, the data preprocessing unit 331 may calculate mean standard deviation with the content information C based on the mean distance M, may sequentially calculate, based on the mean distance M, distance intervals d between pieces of adjacent content information in the order from the closest content information C₁₀ before the mean distance M to the farthest content information C₁₃ after the mean distance M, and may not include content information that is the target of calculation of the subsequent distance intervals in the dataset when the corresponding distance interval d is greater than the mean standard deviation, thus excluding pieces of content information that are located slightly farther away from pieces of content information after the mean distance M from the dataset, with the result that pieces of content data having lower relevance to the provided panoramic image may be prevented from being selected as the hotspot content A.

In an example, the data preprocessing unit 331 of the panoramic image generation apparatus 300 calculates a distance interval di between tenth content information C₁₀, which is the closest content information before the mean distance M, and adjacent eleventh content information C₁₁, based on the mean distance M by the following Equation 4.

$${d}_{11} = \vert {r}_{11} - {r}_{10} \vert \qquad [ Equation 4 ]$$

(where d₁₁ denotes the distance interval between the tenth content information and the eleventh content information, r₁₀ denotes the distance between the tenth content information and the location information, and r₁₁ denotes the distance between the eleventh content information and the location information)

Next, the distance interval du between the tenth content information C₁₀ and the eleventh content information C₁₁ is compared with the mean standard deviation, and the pieces of content information are included in the dataset when the distance interval between the tenth content information C₁₀ and the eleventh content information Cm is not greater than the mean standard deviation.

Subsequently, a distance interval d₁₂ between the eleventh content information C₁₁ and adjacent twelfth content information C₁₂ is calculated by the following Equation 5.

$${d}_{12} = \vert {r}_{12} - {r}_{11} \vert \qquad [ Equation 5 ]$$

(where d₁₂ denotes the distance interval between the eleventh content information and the twelfth content information, r₁₁ denotes the distance between the eleventh content information and the location information, and r₁₂ denotes the distance between the twelfth content information and the location information)

Here, when the distance interval d₁₂ between the eleventh content information C₁₁ and the twelfth content information C₁₂ is less than the mean standard deviation, the twelfth content information C₁₂ may be included in the dataset, but the distance interval between the eleventh content information C₁₁ and the twelfth content information C₁₂ is compared with the mean standard deviation. When the distance interval d₁₂ between the eleventh content information C₁₁ and the twelfth content information C₁₂ is greater than the mean standard deviation, the twelfth content information C₁₂ and thirteenth content information C₁₃, which are pieces of content information to be the target of calculation of subsequent distance intervals, including the twelfth content information C₁₂, may be excluded from the dataset.

When the distance interval between pieces of content information is greater than the mean standard deviation, the data preprocessing unit 331 may terminate the calculation of distance intervals d between pieces of content information C to be subsequently included in the dataset.

Therefore, when it is determined that the distance interval between pieces of content information C is greater than the mean standard deviation, content information C that is target of calculation of subsequent distance intervals is excluded from the dataset to be selected as hotspot content A, and thus content information having lower distance relevance to the panoramic image including the location information O may be excluded from the target of selection of hotspot content, which is displayed together with the panoramic image.

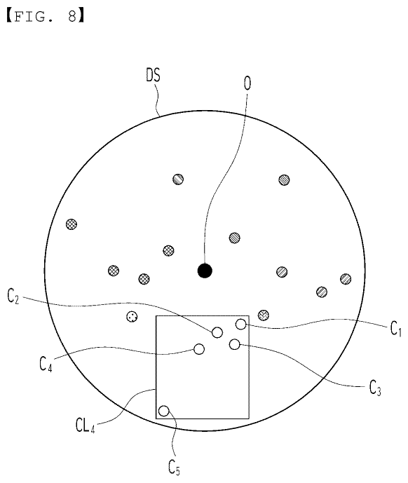

FIG. 7 is an exemplary diagram illustrating a plurality of clusters generated by the panoramic image generation apparatus of FIG. 3.

Referring to FIG. 7, the data selection unit 330 includes the clustering unit 332 to generate at least one to a viewing angle direction by cluster corresponding performing density-based clustering on the dataset based on Euler angles.

Here, each Euler angle may be the value of at least one of yaw, pitch, and roll angles of each piece of content information C based on the location information O, and may be, for example, a yaw value that is a Y-axis rotation angle in a north direction N with respect to the location information O.

At least one cluster may be generated by grouping pieces of content in different directions with respect to the location information O of the panoramic image, so that content information C to be chosen as at least hotspot content A may be selected from the cluster.

In an example, as pieces of content information C included in a dataset DS are grouped along direction references Y₁, Y₂, Y₃, Y₄, Y₅, Y₆, and Y₇ of respective viewing angles with respect to any one direction Y₀ that is the north direction N of the location information O of the panoramic image, seven clusters may be respectively generated.

Here, the direction references may be average values of the Euler angles of respective pieces of content information C based on the location information O of the panoramic image, but they are not limited thereto, and may be the average direction values of pieces of clustered content information C based on the location information O of the panoramic image.

The clustering unit 332 selects some pieces of content information as hotspot content A from among a plurality of pieces of content information concentrated in a specific direction by performing clustering on the dataset DS that is the content information C to be the target of selection of the hotspot content A, and thus the jumbling of hotspot content, displayed on the panoramic image, which occur as the plurality of pieces of content information are present, may be further simplified and provided, and the user may check surrounding content information having higher relevance to the panoramic image through the provision of the hotspot content.

FIG. 8 is an exemplary diagram illustrating a process in which the panoramic image generation apparatus of FIG. 3 determines the number of pieces of hotspot content for each cluster.

Referring to FIG. 8, the clustering unit 332 of the panoramic image generation apparatus 300 may determine hotspot content among pieces of content information included in each cluster.

Here, the clustering unit 332 may determine the number of pieces of hotspot content A for each cluster based on the number of pieces of content information C₁, C₂, C₃, C₄, and C₅ included in the corresponding cluster.

Here, the data selection unit 330 may include the data post-processing unit 333 that calculates content importance based on the popularity of the content information, address similarity between location information and the content information, and the distance between the location information and the content information, and that selects the pieces of hotspot content A in descending order of content importance.

In detail, the data post-processing unit 333 may calculate the content importance based on the popularity of each piece of content information in each cluster, the address similarity between the location information and the corresponding content information, and the distance between the location information and the corresponding content information.

In an example, five pieces of content information C₁, C₂, C₃, C₄, and C₅ are included in a fourth cluster CL₄, and then parameters for the popularity of each piece of content information, the address similarity between the location information and the corresponding content information, and the distance between the location information and the corresponding content information may be represented as follows.
C₁={popularity 20, address similarity 0.56, distance 1.7}
C₂={popularity 25, address similarity 0.56, distance 1.7}
C₃={popularity 10, address similarity 0.56, distance 2.2}
C₄={popularity 30, address similarity 0.48, distance 2.5}
C₅={popularity 10, address similarity 0.28, distance 2.8}

The importance of content information C may be calculated by the following Equation 6 based on the parameters of the content information C.

Weight=(popularity×α₁)+(address similarity×α₂)+(distance×α₃) [Equation 6]
(Weight: content importance of content information, α₁: popularity weight, α₂: address similarity weight, α₃: distance weight)

When the above Equation and individual parameters of the content information are applied, content importance values of respective pieces of content information may be calculated as follows.
Content importance of first content information C₁={weight: 100}
Content importance of second content information C₂={weight: 154}
Content importance of third content information C₃={weight: 92}
Content importance of fourth content information C₄={weight: 148}
Content importance of fifth content information C₅={weight: 76}

The clustering unit 332 may determine the number of pieces of hotspot content for each cluster using the following Equation 3.

$$N \leq a + ( b \times k ) ( where N is an integer )$$

(where N denotes the number of pieces of hotspot content for each cluster, a denotes the minimum number of pieces of hotspot content for each cluster, b denotes the ratio of additionally selected content information to the total number of pieces of content information for each cluster, and k denotes the total number of pieces of content information for each cluster)

Here, in the case where the minimum number of pieces of hotspot content for each cluster is 1 and the ratio of additionally selected content information to the total number of pieces of content information for each cluster is 0.1, the number of pieces of content information C₁, C₂, C₃, C₄, and C₅ included in the cluster is 5, and thus the number of pieces of hotspot content for each cluster is determined to be 1. As a result, the second content information C₂ having the highest content importance, among the five pieces of content information C₁, C₂, C₃, C₄, and C₅ included in the cluster, may be selected as the hotspot content, and the hotspot content, together with the panoramic image, may be provided to the user device 100.

The selected hotspot content may be provided, together with the panoramic image, and thereby the hotspot content A may be provided to the user in the form of a hotspot in the positional direction of the content information selected as the hotspot content A based on the location information O of the panoramic image.

According to the present embodiment, since hotspot content A may be selected based on content information having higher relevance from among pieces of content information closer to the location information O of the provided panoramic image, there is an advantage in that a user may view hotspot content A that is selected content information present in each direction based on the location information O of the panoramic image, together with the panoramic image.

In the above description, although embodiments of the present disclosure have been described, it is apparent that the present disclosure is not limited thereto and various modifications and substitutions are possible within the scope of the claims, detailed description, and drawings of the present disclosure, and that these modifications and substitutions also fall within the scope of the present disclosure.

### DETAILED DESCRIPTION

A mode for implementing the discourse has been described together in the best mode for implementing the disclosure.

### INDUSTRIAL APPLICABILITY

The present disclose relates to an apparatus and method for generating a panoramic image using content information, and is applicable to various apparatuses or methods for generating panoramic image content, thus achieving industrial applicability due to the reproducibility thereof.

What is claimed is:

1. A panoramic image generation apparatus, comprising:
a reception unit configured to receive input information required to provide a panoramic image;
an image provision unit configured to provide the panoramic image to a user based on the input information; and
a data selection unit configured to select hotspot content having higher relevance to the panoramic image from among pieces of content information located within a preset range based on location information of the panoramic image,
wherein the image provision unit provides the panoramic image together with the hotspot content.

2. The panoramic image generation apparatus of claim 1, wherein the data selection unit comprises:
a data preprocessing unit configured to calculate a mean distance to the content information based on the location information, and determine, based on the calculated mean distance, whether the content information is included in a dataset that is a target of selection of the hotspot content.

3. The panoramic image generation apparatus of claim 2, wherein the data preprocessing unit is configured to:
calculate a mean standard deviation with the content information based on the mean distance,
sequentially calculate, based on the mean distance, distance intervals between pieces of adjacent content information in an order from closest content information before the mean distance to farthest content information after the mean distance, and
when a corresponding distance interval is greater than the mean standard deviation, exclude content information that is a target of calculation of subsequent distance intervals from the dataset.

4. The panoramic image generation apparatus of claim 2, wherein the data selection unit comprises:
a clustering unit configured to generate at least one cluster corresponding to a viewing angle direction by performing density-based clustering on the dataset based on an Euler angle.

5. The panoramic image generation apparatus of claim 4, wherein the clustering unit determines a number of pieces of hotspot content for each cluster based on a number of pieces of content information included in a corresponding cluster.

6. The panoramic image generation apparatus of claim 5, wherein the clustering unit determines the number of pieces of hotspot content for each cluster using the following equation:
$$N \leq a + ( b \times k ) ( where N is an integer ) \qquad equation$$
(where N denotes the number of pieces of hotspot content for each cluster, a denotes a minimum number of pieces of hotspot content for each cluster, b denotes a ratio of additionally selected content information to a total number of pieces of content information for each cluster, and k denotes the total number of pieces of content information for each cluster).

7. The panoramic image generation apparatus of claim 6, wherein the minimum number of pieces of hotspot content for each cluster is at least one.

8. The panoramic image generation apparatus of claim 1, wherein the data selection unit comprises:
a data post-processing unit configured to calculate content importance based on popularity of the content information, an address similarity between the location information and the content information, and a distance between the location information and the content information, and select the hotspot content in descending order of content importance.

9. The panoramic image generation apparatus of claim 8, wherein the data post-processing unit is configured to:
calculate the content importance differently depending on a category in which the panoramic image is displayed,
when the category is a Social Network Service (SNS), calculate the content importance by setting a weight applied to the popularity to a value greater than a weight applied to the distance between the location information and the content information, and
when the category is a road view, calculate the content importance by setting the weight applied to the distance between the location information and the content information to a value greater than the weight applied to the popularity.

10. A panoramic image generation method using a panoramic image generation apparatus, comprising:
an input information reception step of receiving input information required to provide a panoramic image;
a data selection step of selecting hotspot content having high relevance to the panoramic image from among pieces of content information located within a preset range based on location information of the panoramic image; and
an image provision step of providing the panoramic image to a user based on the input information,
wherein the image provision step comprises providing the panoramic image together with the hotspot content.

11. The panoramic image generation method of claim 10, wherein the data selection step comprises:
a data preprocessing step of calculating a mean distance to the content information based on the location information and determining, based on the calculated mean distance, whether the content information is included in a dataset that is a target of selection of the hotspot content.

12. The panoramic image generation method of claim 11, wherein the data preprocessing step comprises:
calculating a mean standard deviation with the content information based on the mean distance,
sequentially calculating, based on the mean distance, distance intervals between pieces of adjacent content information in an order from closest content information before the mean distance to farthest content information after the mean distance, and
when a corresponding distance interval is greater than the mean standard deviation, excluding content information that is a target of calculation of subsequent distance intervals from the dataset.

13. The panoramic image generation method of claim 11, wherein the data selection step comprises:
a clustering step of generating at least one cluster corresponding to a viewing angle direction by performing density-based clustering on the dataset based on an Euler angle.

14. The panoramic image generation method of claim 13, wherein the clustering step comprises:
determining a number of pieces of hotspot content for each cluster based on a number of pieces of content information included in a corresponding cluster.

15. The panoramic image generation method of claim 14, wherein:
in the clustering step,
the number of pieces of hotspot content for each cluster is determined using the following equation:
$$N \leq a + ( b \times k ) ( where N is an integer ) \qquad equation$$
(where N denotes the number of pieces of hotspot content for each cluster, a denotes a minimum number of pieces of hotspot content for each cluster, b denotes a ratio of additionally selected content information to a total number of pieces of content information for each cluster, and k denotes the total number of pieces of content information for each cluster).

16. The panoramic image generation method of claim 15, wherein the minimum number of pieces of hotspot content for each cluster is at least one.

17. The panoramic image generation method of claim 11, wherein the data selection step comprises:
a data post-processing step of calculating content importance based on popularity of the content information, an address similarity between the location information and the content information, and a distance between the location information and the content information, and selecting the hotspot content in descending order of content importance.

18. The panoramic image generation method of claim 17, wherein the data post-processing step comprises:
calculating the content importance differently depending on a category in which the panoramic image is displayed,
when the category is a Social Network Service (SNS), calculating the content importance by setting a weight applied to the popularity to a value greater than a weight applied to the distance between the location information and the content information, and
when the category is a road view, calculating the content importance by setting the weight applied to the distance between the location information and the content information to a value greater than the weight applied to the popularity.
